(19) United States
(12) Patent Application Publication
(10) Pub. No.: US 2016/0026432 A1
(43) Pub. Date: Jan. 28, 2016

(54) Method to broadcast internet voice news

(71) Applicant: Hong Li, Weihai (CN)

(72) Inventor: Hong Li, Weihai (CN)

(21) Appl. No.: 14/813,148

(22) Filed: Jul. 30, 2015

(30) Foreign Application Priority Data
Apr. 30, 2015 (CN) 201510228097.6

(51) Int. Cl. G06F 3/16; H04W 4/06

(52) U.S. Cl. CPC G06F 3/167; H04W 4/06; G06F 3/162

(57) ABSTRACT

A voice internet system comprises voice websites and internet broadcasting devices. When an internet broadcasting device logs into a voice website through Internet, it will broadcast voice news headlines. When a news headline is being broadcasted, pushing a play button on a control panel on the internet broadcasting device or giving a voice command, the corresponding news content under the headline will be broadcasted with voice. After completion of broadcasting the news content, the remaining headlines will be broadcasted.

### TECHNICAL FIELD

The present invention relates to mobile internet with voice content.

### BACKGROUND

Currently, radio stations still remains in the state of continuous broadcasting, and audience could not search or select program. A listener often has to listen to programs that are not interesting, or has to often change channels to find an interesting program.

Internet technologies enable people to search and find interesting subjects, and then read. But sometimes many people are unable to continuously stare at computer screen, so unable to log on internet to read online. For example, people who are driving or working cannot read online. People who are blinded or have eye decease cannot read online too. Also, read online for long time could make eyes tired.

Although voice search can be done online, but there is no voice readout of written content from search results. There is no voice list to select content either.

Although there are internet radios, but a user has to stare at a computer screen to log in and to play, by moving a computer mouse and click icons. There is no voice list to select content either.

So, there is a need to have internet with voice broadcast to select and listen to interesting content, and to filter out content that is not interesting, without using eyes to search and read.

### SUMMARY OF THE INVENTION

In the present voice internet system, voice headlines and control buttons are used to replace icons and mouse of the current text websites. When a listener is interested in a news headline being played, can listen to the corresponding news content, by pushing a control button. In this way, audience can select and listen to voice programs interested, and their interests and efficiency are enhanced.

### DETAILED DESCRIPTION

According to the present invention, the voice internet system consists of voice websites and internet broadcast devices.

Each voice website comprises an internet server, an operational program, and an encoder.

Each voice website publishes voice news, including categories, headlines and contents. Voice news can be manually recorded, or transformed from writing by “word to speech” software. The voice website updates voice news headlines and contents daily.

The voice website replaces written information on a text website with voice information. Some written information such as table is not suitable for the voice website. Some text may not be easy to understand by listening, and should be changed to oral language.

The encoder digitizes and marks each voice program information for link, control and broadcast. The beginning, duration, and sequence of each voice program are marked. In the voice website, each voice news headline and corresponding voice content are interlinked; headlines belong to the same category are put into the same file folder and linked to the folder name; headlines in a folder are placed in sequence so they will be broadcasted by the sequence when the holder is opened. A folder name is the category of headlines, such as general, finance, entertainment, sports, health, real estates, automobile and so on, which will be saved and published as a voice file. In the entertainment category, list and contents of news can be replaced by list and contents of music, stories and other entertainment programs.

A voice website can also publish voice advertises, which will be marked to be inserted into suitable places in news headlines and contents. The voice advertises include local advertises. When an internet broadcast device logs into the voice website and plays a voice program, it can down load and play local advertises suitable for the region where the internet broadcast device is located.

Each of the internet broadcast device has a central processor, an operation program, a memory, and a decoder; has a network card and a browser to log into the voice website; has a sound card and a voice player to broadcast voice programs; and has a control panel. The control panel has control buttons and display screen. Text displayed on the screen matches a button pushed on the keyboard and a voice program being broadcasted.

When a button on a control panel is pushed during broadcasting a voice program, a voice player switches to a linked program according to the time, and the type of the signal from the button. That is just like a music player of a computer, except that an icon and a mouse of the music player are replaced by a voice headline and a control button of a voice player.

When using an internet broadcast device, turn on its power switch; push a “website” button with a number on its control panel. A website will be logged in through its address pre-linked to the button. There can be a few “website” buttons for selection, to log into different websites. After logged into a website, news categories will be broadcasted one by one with voice. After voice news categories have been broadcasted, voice news headlines on each category will be broadcasted.

Or when a listener heard an interesting news category, push a “play/stop” button on the control panel, the voice news headlines linked to the category will be broadcasted.

Or after logged into a voice website, pushing a “news category” button on control panel with a number. News headlines under the category will be broadcasted which was pre-linked to the button. There are a few “news category” buttons to choose, such as general, finance, entertainment, sports, health, real estates, automobile and so on.

When the power switch is turned on again, the website and the category will be logged in the same as the last time, and the updated news headlines under the category will be broadcasted.

When a listener heard an interesting news headline being broadcasted by an internet broadcast device, can listen to its corresponding news content by pushing a “play/stop” button on a control panel. During broadcasting news content, push the “play/stop” button, broadcasting will stop. Push the “play/stop” button again, broadcasting will resume from where it stopped. After completion of broadcasting the news content, the remaining headlines will be broadcasted.

For those who are driving or cannot stare at screen, pushing a button is much easier than moving a mouse to an icon on a computer screen and then clicking. A real button can be located by touching and memory, or by split vision of eyes. A real button will be much easier to locate and identify than a touch screen button. A real button can have different shape such as round, squire, and have convex-concave to touch and distinguish.

To conveniently push a control button while drive, a control panel can be installed on car steering wheel. There can be a remote control panel.

On a control panel, there are “forward” button and “backward” button to broadcast previous and next program respectively.

There is also a “save” button on a control panel to save a category to a button. After logged into a website, categories on the website are broadcasted one by one. When heard or seen on display an interesting category, push the “save” button, and push a category button with a number, then the category is saved on the button.

To save a voice website address, first insert a U disk with a voice website address. When the website address appears on the display, push the “save” button, and push a “website” button with a number, then the website address is saved on the button.

There is also a “search” button to search voice websites. After the “search” button is pushed, addresses of voice websites searched out will be displayed one by one on the display screen. Push the “play/stop” button, the website displayed will be logged in. Then, push the “save” button and push a “website” button, then the website address is saved on the “website” button.

The functions of the buttons can be replaced by voice commands. For example, saying “play” can replace pushing a “play” button. A microphone on an internet broadcast device can be used to receive voice commands.

Infrared motion sensors could also be used to replace the control buttons. When a finger moves close to the sensor, the sensor will give a voice player a command signal, just like a motion sensor of a door for automatic control.

The internet broadcast devices of the present invention are suitable for mobile players, such as car radios, smart cell phones, and portable radios.

1. A voice internet comprises voice websites and internet broadcasting devices. Each of the voice websites comprises an internet server, an operational program, and an encoder. The voice websites publish voice program information, including voice news headlines and contents. The voice program information is digitized and marked by the encoder for link, control and broadcast. The beginning, duration, and sequence of each voice program information are marked. In the voice website, each news headline and its corresponding content are interlinked; headlines belong to the same category are put into the same file folder and linked to the folder name; headlines in a folder are placed in sequence so that they will be broadcasted by the sequence when the holder is opened. Each of the internet broadcasting devices has a central processor, an operation program, a memory, and a decoder; has a network card and a browser to log into the voice websites; has a sound card and a voice player to broadcast voice programs; and has a control panel. When an internet broadcasting device logs into a voice website, it will broadcast voice news headlines. Pushing a play button on a control panel when a news headline is being broadcasted by the internet broadcasting device, its voice player switches to the linked news content according to the time and the type of the signal from the button, so that the corresponding news content under the headline will be broadcasted with voice. After completion of broadcasting the news content, the remaining headlines will be broadcasted.

2. The method of claim 1 wherein the control panel is a remote control device.

3. The method of claim 1 wherein the control panel is installed on a car steering wheel.

4. The method of claim 1 wherein the voice website also publishes voice advertises.

5. The method of claim 4 wherein the voice advertises include local advertises which is suitable to an internet voice player's location and can be down loaded to the internet voice player.

6. A method of broadcasting internet voice news comprises: publishing voice news categories, headlines and contents by a voice website; logging into the voice website through the internet by an internet voice player; selecting and listening voice news categories, headlines and contents by controlling said internet voice player.

7. The method of claim 6 wherein the internet voice player is controlled by pushing a button.

8. The method of claim 6 wherein the internet voice player is controlled by giving a voice command.
